(19) United States
(12) Patent Application Publication
(10) Pub. No.: US 2024/0422128 A1
(43) Pub. Date: Dec. 19, 2024

(54) APPARATUS FOR FILTERING ETHERNET PACKETS AND METHOD THEREOF

(71) Applicants: Hyundai Motor Company, Seoul (KR); Kia Corporation, Seoul (KR)

(72) Inventor: Ho Jin Jung, Bucheon-si (KR)

(21) Appl. No.: 18/469,699

(22) Filed: Sep. 19, 2023

(30) Foreign Application Priority Data
Jun. 19, 2023 (KR) 10-2023-0078360

(51) Int. Cl. H04L 9/40; H04L 49/351; H04L 67/12

(52) U.S. Cl. CPC H04L 63/0236; H04L 49/351; H04L 63/162; H04L 67/12

(57) ABSTRACT

An embodiment of an Ethernet packet filtering apparatus and a method thereof are disclosed. The Ethernet packet filtering apparatus can include ports to which electronic control units (ECUs) in a vehicle are connected, and a controller that performs a deep pocket inspection (DPI) on Ethernet packets of a data link level received through the ports, that detects an Ethernet packet requesting a specific service among unified diagnostic services (UDS), and that filters the detected Ethernet packet.

### CROSS-REFERENCE TO RELATED APPLICATIONS

This application claims the benefit of Korean Patent Application No. 10-2023-0078360, filed on Jun. 19, 2023, which application is hereby incorporated herein by reference.

### TECHNICAL FIELD

The present disclosure relates to a technique for filtering Ethernet packets that may compromise electronic control units (ECUs) of a vehicle.

### BACKGROUND

In general, in CAN (Controller Area Network) communication between ECUs (Electronic Control Units) in a vehicle, not only the amount (8 bytes) of data that can be recorded in the payload of a CAN message is small, but the transmission speed is also slower than that of Ethernet. Accordingly, Ethernet has recently been introduced for communication between the ECUs in the vehicle.

By introducing Ethernet for communication between the ECUs in the vehicle, it is possible to improve transmission speed and lower manufacturing cost of the system, and to simplify wiring and connection structure between ECUs by directly connecting an ECU local network to a Main System Bus.

To transmit Ethernet packets between ECUs in the vehicle, an Ethernet switch should be provided in the vehicle network, and this Ethernet switch is a layer 2 (data link layer) equipment and has a structure in which one ECU is connected to one port.

The Ethernet switch may detect a connection between the connector of a diagnostic device and a first port, may set a connection with the diagnostic device by referring to a Virtual Local Area Network (VLAN) ID table, may set a connection with the ECUs in the vehicle by referring to the VLAN ID table, may perform a certificate based secure access procedure with the diagnostic device, may switch a mode of the Ethernet switch from a lock mode to an unlock mode, and may set a connection between the diagnostic device and the ECUs in the vehicle by referring to the VLAN ID table.

In addition, the Ethernet switch may switch a mode of the Ethernet switch from an unlock mode to a lock mode when the diagnostic session of the diagnostic device is terminated or the connector of the diagnostic device is disconnected from the first port, and may release the connection between the diagnostic device and the ECUs in the vehicle.

In the process of performing the certificate based secure access procedure with the diagnostic device, the controller provided in the Ethernet switch may switch a mode of the Ethernet switch from a lock mode to an unlock mode when authentication of the diagnostic device is completed, and may set the connection between the diagnostic device and the ECUs in the vehicle. Then, the diagnostic device may access the ECU in the vehicle.

Before performing the certificate based secure access procedure, the diagnostic device can only access a controller of the Ethernet switch. Therefore, the diagnostic device may perform On-Board Diagnostics (OBD) regulation diagnosis or OEM general diagnosis functions.

After the certificate based secure access procedure is performed, the diagnostic device can access the ECUs in the vehicle. Therefore, the diagnostic device may perform all diagnosis functions including OBD regulation diagnosis.

This certificate based secure access procedure does not simply use a Seed & Key method, but may include a series of processes of transferring a certificate stored in the diagnostic device to the Ethernet switch, verifying the certificate using a public key of the authentication server pre-stored in the Ethernet switch, obtaining the public key, and transmitting a symmetric key encrypted by the Ethernet switch based on the public key of the diagnostic device to the diagnostic device.

Meanwhile, the Ethernet switch may filter inappropriate Ethernet packets based on an Access Control List (ACL) in which MAC (Media Access Control) addresses and IP (Internet Protocol) addresses are recorded. In detail, because the Ethernet switch filters inappropriate Ethernet packets based on the MAC address and IP address inserted into the Ethernet packet, the inappropriate Ethernet packets cannot be filtered when the MAC address or IP address is hacked by a hacker.

In addition, the Ethernet switch cannot detect an ECU that transmits an inappropriate Ethernet packet in the vehicle, that is, the ECU hacked in the vehicle.

Matters described in this background section are prepared to enhance understanding of the background of the disclosure, and may include matters that are not prior art already known to those skilled in the art to which this technique belongs.

### SUMMARY

The present disclosure relates to a technique for filtering Ethernet packets that may compromise electronic control units (ECUs) of a vehicle. The present disclosure has been made to solve the above-mentioned problems occurring in the prior art while advantages achieved by the prior art are maintained intact.

An embodiment of the present disclosure provides an apparatus for filtering Ethernet packets and a method thereof capable of filtering Ethernet packets received from hacked ECUs (Electronic Control Units) as well as detecting hacked ECUs among ECUs in a vehicle, by performing a DPI (Deep Packet Inspection) on Ethernet packets of the data link level (Layer 2) received from the ECUs in the vehicle, detecting an Ethernet packet requesting a specific service among Unified Diagnostic Services (UDS), and filtering the detected Ethernet packet.

An embodiment of the present disclosure provides an apparatus for filtering Ethernet packets and a method thereof capable of filtering Ethernet packets received from hacked ECUs (Electronic Control Units) as well as detecting hacked ECUs among ECUs in a vehicle, in a state having a table in which commands for blocking a specific service request Ethernet packet ingress through an unauthorized port are recorded, by performing a DPI (Deep Packet Inspection) on Ethernet packets of the data link level (Layer 2) received from the ECUs in the vehicle and filtering inappropriate Ethernet packets based on the table.

Technical problems solved by the present disclosure are not necessarily limited to the aforementioned problems, and any other technical problems not mentioned herein can be clearly understood from the following description by those skilled in the art to which the present disclosure pertains. In addition, it can be easily understood that advantages of the disclosure are realized by embodiments and combinations thereof described in the appended claims.

According to an embodiment of the present disclosure, an Ethernet packet filtering apparatus includes a plurality of ports to which ECUs (Electronic Control Units) in a vehicle are connected, and a controller that performs a DPI (Deep Packet Inspection) on Ethernet packets of a data link level received through the plurality of ports, which detects an Ethernet packet requesting a specific service among Unified Diagnostic Services (UDS), and that filters the detected Ethernet packet.

According to an embodiment, the controller may filter the Ethernet packet when an ID corresponding to the specific service is recorded in a payload of the Ethernet packet.

According to an embodiment, the controller may inspect data byte #12 of the payload in the Ethernet packet.

According to an embodiment, the specific service can be any one of 0x31 (Routine Control), 0x34 (Request Download), 0x36 (Transfer Data), 0x37 (Request Transfer Exit), 0x2F (Input/Output Control), 0x2E (Write Data By Identifier), and 0x3D (Write Memory By Address).

According to an embodiment, the Ethernet packet filtering apparatus can be an Ethernet switch operating at a data link layer.

According to an embodiment of the present disclosure, an Ethernet packet filtering apparatus includes a table in which commands for blocking specific service request Ethernet packets ingress through unauthorized ports are recorded, and a controller that performs a DPI (Deep Packet Inspection) on Ethernet packets of a data link level received from ECUs (Electronic Control Units) in a vehicle and filters out an inappropriate Ethernet packet based on the table.

According to another embodiment, the controller can determine the Ethernet packet as the inappropriate Ethernet packet when an ID corresponding to the specific service is recorded in a payload of the received Ethernet packet.

According to another embodiment, the controller can inspect data byte #12 of the payload in the Ethernet packet.

According to another embodiment, the specific service can be any one of 0x31 (Routine Control), 0x34 (Request Download), 0x36 (Transfer Data), 0x37 (Request Transfer Exit), 0x2F (Input/Output Control), 0x2E (Write Data By Identifier), and 0x3D (Write Memory By Address).

According to another embodiment, the Ethernet packet filtering apparatus can be an Ethernet switch operating at a data link layer.

According to an embodiment of the present disclosure, an Ethernet packet filtering method includes connecting a plurality of ports to ECUs (Electronic Control Units) in a vehicle, performing, by a controller, a DPI (Deep Packet Inspection) on Ethernet packets of a data link level received through the plurality of ports, detecting, by the controller, an Ethernet packet requesting a specific service among Unified Diagnostic Services (UDS), and filtering, by the controller, the detected Ethernet packet.

According to an embodiment, the filtering of the detected Ethernet packet can include filtering the Ethernet packet when an ID corresponding to the specific service is recorded in a payload of the Ethernet packet.

According to an embodiment, the filtering of the detected Ethernet packet can further include inspecting data byte #12 of the payload in the Ethernet packet.

According to an embodiment, the performing of the DPI can include performing, by the controller provided in an Ethernet switch operating in a data link layer, the DPI on the received Ethernet packet.

### BRIEF DESCRIPTION OF THE DRAWINGS

The above and other features and advantages of the present disclosure can be more apparent from the following detailed description taken in conjunction with the accompanying drawings:

FIG. 1 is a configuration diagram of an Ethernet packet filtering apparatus, according to an embodiment of the present disclosure;

FIG. 2 is a diagram illustrating a structure of a general Ethernet packet as an example;

FIG. 3 is a diagram illustrating a structure of a general DoIp packet as an example;

FIG. 4 is a diagram illustrating a table provided in an Ethernet packet filtering apparatus, according to an embodiment of the present disclosure as an example;

FIG. 5 is a diagram for describing an operation of a controller provided in an Ethernet packet filtering apparatus, according to an embodiment of the present disclosure as an example;

FIG. 6 is a flowchart of an Ethernet packet filtering method according to an embodiment of the present disclosure; and

FIG. 7 is a block diagram illustrating a computing system for executing an Ethernet packet filtering method, according to an embodiment of the present disclosure.

### DETAILED DESCRIPTION OF ILLUSTRATIVE EMBODIMENTS

Hereinafter, some embodiments of the present disclosure will be described in detail with reference to the drawings. In adding the reference numerals to the components of each drawing, it should be noted that the identical or equivalent component is designated by the identical numeral even when they are displayed on other drawings. Further, in describing an embodiment of the present disclosure, a detailed description of the related known configuration or function can be omitted when it is determined that it interferes with the understanding of the embodiment of the present disclosure.

In describing the components of an embodiment according to the present disclosure, terms such as first, second, A, B, (a), (b), and the like can be used. These terms can be merely intended to distinguish the components from other components, and the terms do not necessarily limit the nature, order, or sequence of the components. Unless otherwise defined, all terms including technical and scientific terms used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

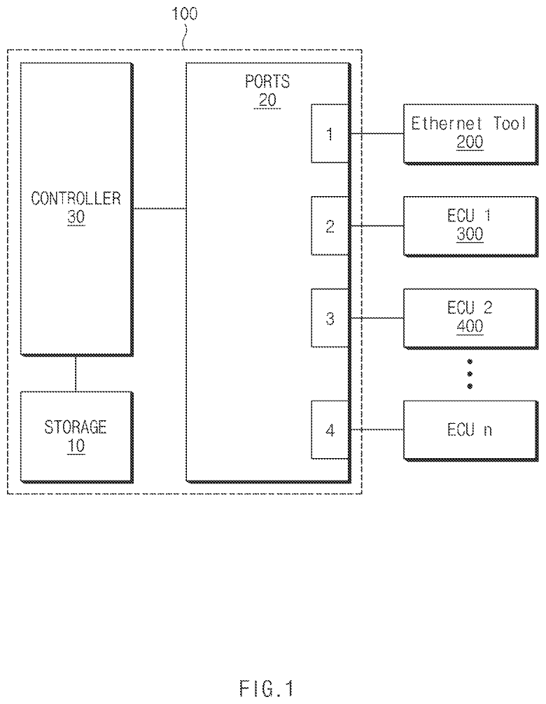

FIG. 1 is a configuration diagram of an Ethernet packet filtering apparatus, according to an embodiment of the present disclosure.

As illustrated in FIG. 1, an Ethernet packet filtering apparatus 100 according to an embodiment of the present disclosure can include storage 10, a plurality of ports 20, and a controller 30. In this case, according to a method of implementing the Ethernet packet filtering apparatus 100 according to an embodiment of the present disclosure, each component can be combined with each other to be implemented as one, or some components can be omitted. In addition, the Ethernet packet filtering apparatus 100 can be implemented as an Ethernet switch belonging to a data link layer among OSI 7 layers, for example.

Looking at each of the above components, first, the storage 10 can store various logics, algorithms, and programs used in processes of performing a DPI (Deep Packet Inspection) on Ethernet packets of a data link level (Layer 2) received from the ECUs (Electronic Control Units) in a vehicle, detecting an Ethernet packet requesting a specific service among Unified Diagnostic Services (UDS), and filtering the detected Ethernet packet.

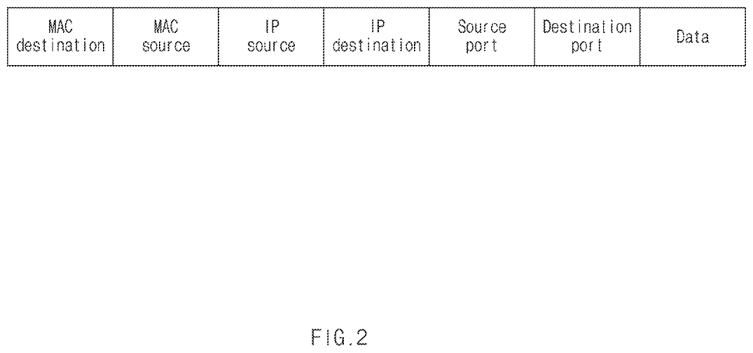

The storage 10 can store a table in which a command for blocking an Ethernet packet is recorded when the Ethernet packet requesting a specific service is ingressed through an unauthorized port. In this case, the Ethernet packet (or a frame) can be as illustrated in FIG. 2, for example.

FIG. 2 is a diagram illustrating a structure of a general Ethernet packet as an example.

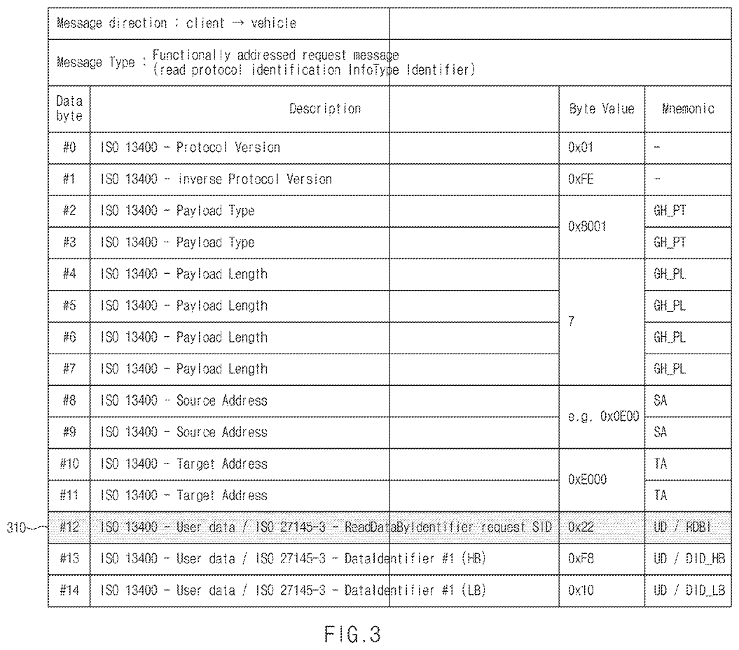

As illustrated in FIG. 2, the Ethernet packet includes a destination MAC (MAC destination), a source MAC (MAC source), a source IP (IP source), a destination IP (IP destination), a source port (Source Port), a destination port (Destination Port), and data. In this case, the Ethernet packet can be a Diagnostic over Internet Protocol (DoIP) packet. For reference, the DoIP packet is a protocol that allows a remote vehicle to be diagnosed online, and a user can check the state of ECUs in the vehicle through a diagnostic message online or offline. As an example, a structure of the DoIP packet is as illustrated in FIG. 3.

FIG. 3 is a diagram illustrating a structure of a general DoIP packet as an example.

As illustrated in FIG. 3, the DoIP packet is an international standard format, and a payload located after a TCP (Transmission Control Protocol) header can include a protocol version, an inverse protocol version, a payload type, a payload length, a source address, a target address, a request service ID 310 (SID), and a data ID (DID). In this case, the request service ID 310 corresponds to data byte #12, the request service ID 310 is 1 byte, and the data ID is 2 bytes. Through the structure of the DoIP packet, it can be confirmed that the request service ID 310 is recorded in the data byte #12.

The request service ID 310 is a Unified Diagnostic Service (UDS), and cannot include all UDSs due to the limitations of the memory capacity of an Ethernet switch. Therefore, a specific service that can compromise the ECU is selected. For example, among UDS, the specific services can include 0x31 (Routine Control), 0x34 (Request Download), 0x36 (Transfer Data), 0x37 (Request Transfer Exit), 0x2F (Input/Output Control), 0x2E (Write Data By Identifier), or 0x3D (Write Memory By Address).

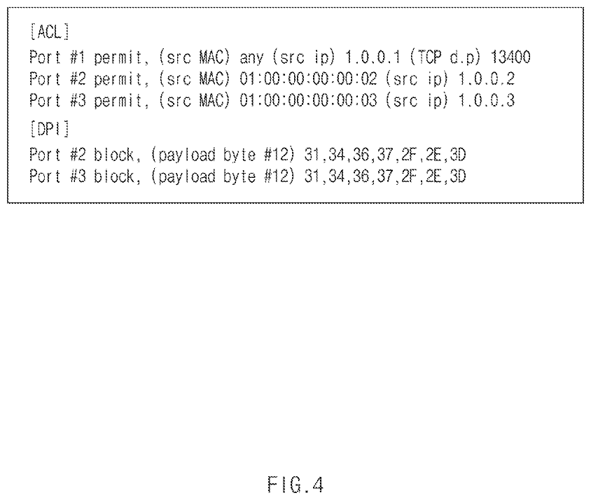

FIG. 4 is a diagram illustrating a table provided in an Ethernet packet filtering apparatus, according to an embodiment of the present disclosure as an example.

As illustrated in FIG. 4, a table is an ACL, and can include a first command that is permitted when the source IP is 1.0.0.1 and the TCP destination port is 13400, even though there is no restriction on the source MAC among the Ethernet packets ingress through a first port (Port #1), a second command that is permitted when the source MAC is 01:00:00:00:00:02 and the source IP is 1.0.0.2 among the Ethernet packets ingress through a second port (Port #2), and a third command that is permitted when the source MAC is 01:00:00:00:00:03 and the source IP is 1.0.0.3 among the Ethernet packets ingress through a third port (Port #3).

In addition, the table is a DPI, and can include a fourth command for blocking Ethernet packets of which request service IDs recorded in the payload byte #12 are 31, 34, 36, 37, 2F, 2E, and 3D among the Ethernet packets ingress through the second port (Port #2), and a fifth command for blocking Ethernet packets of which request service IDs recorded in the payload byte #12 are 31, 34, 36, 37, 2F, 2E, or 3D among the Ethernet packets ingress through the third port (Port #3).

The storage 10 can store various logics, algorithms, and programs used in processes of performing a DPI (Deep Packet Inspection) on Ethernet packets of a data link level (Layer 2) received from the ECUs (Electronic Control Units) in a vehicle, and filtering inappropriate Ethernet packets based on the table.

The storage 10 can include at least one type of storage medium of a memory such as a flash memory type, a hard disk type, a micro type, a card type (e.g., an SD card (Secure Digital Card) or an XD card (eXtream Digital Card)), a memory such as a RAM (Random Access Memory), an SRAM (Static RAM), a ROM (Read-Only Memory), a PROM (Programmable ROM), an EEPROM (Electrically Erasable PROM), an MRAM (magnetic RAM), a magnetic disk, optical disk type memory, or any combination thereof.

The plurality of ports 20 can be connected to an Ethernet tool 200, a first ECU 300, and a second ECU 400, for example. There can be any number (n) of ports. In this case, the Ethernet tool 200, as a kind of reprogramming tool, has a unique MAC address, a unique IP address, and a unique destination port, and can perform diagnostic commands for the ECUs in the vehicle when authentication is completed. In addition, each of the first ECU 300 and the second ECU 400 has a unique MAC address and a unique IP address.

The controller 30 can perform overall control such that each of the components can perform their functions normally. The controller 30 can be implemented in the form of hardware, or can be implemented in the form of software, or can be implemented in the form of a combination of hardware and software. Preferably, the controller 30 can be implemented as a microprocessor, but is not necessarily limited thereto.

In particular, the controller 30 can perform a DPI (Deep Packet Inspection) on Ethernet packets of the data link level (Layer 2) received from the ECUs (Electronic Control Units) in the vehicle, can detect Ethernet packets requesting a specific service among Unified Diagnostic Services (UDS), and can filter the detected Ethernet packets. In this case, the controller 30 can inspect not only source information and destination information of the Ethernet packet but also the content of the payload in the Ethernet packet as a DPI process.

In addition, in a state having a table in which commands for blocking a specific service request Ethernet packet ingress through an unauthorized port are recorded, the controller 30 can perform a DPI (Deep Packet Inspection) on Ethernet packets of the data link level (Layer 2) received from the ECUs in the vehicle and can filter inappropriate Ethernet packets based on the table.

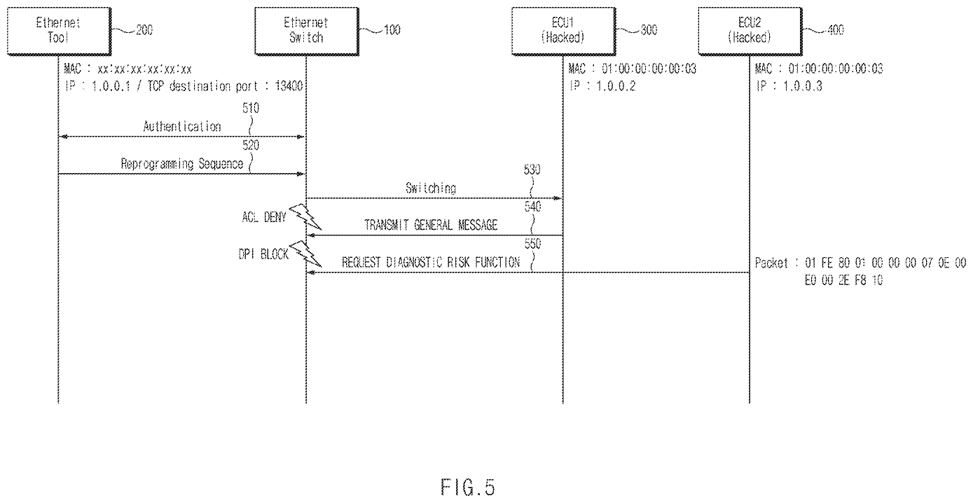

Hereinafter, an operation of the controller 30 will be described in detail with reference to FIG. 5.

FIG. 5 is a diagram for describing an operation of a controller provided in an Ethernet packet filtering apparatus, according to an embodiment of the present disclosure as an example.

As illustrated in FIG. 5, the Ethernet tool 200 has a unique MAC address (e.g., xx:xx:xx:xx:xx:xx), a unique IP address (e.g., 1.0.0.1), and a unique destination port (e.g., 13400).

The first ECU 300 has a unique MAC address (e.g., 01:00:00:00:00:02) and a unique IP address (1.0.0.2), but has a changed MAC address (e.g., 01:00:00:00:00:03) by currently hacking by a hacker.

Although the second ECU 400 is currently hacked by a hacker, the second ECU 400 maintains a unique MAC address (e.g., 01:00:00:00:00:03) and a unique IP address (e.g., 1.0.0.3).

First, the Ethernet tool 200 performs an authentication process with the controller 30 within the Ethernet switch 100 (510). In this case, the Ethernet tool 200 should be authenticated by the controller 30 to perform diagnosis on the first ECU 300 or the second ECU 400.

Thereafter, the Ethernet tool 200 for which authentication is completed can transfer a reprogramming sequence to the Ethernet switch 100 (520).

Thereafter, the controller 30 transmits the reprogramming sequence to the first ECU 300 (530) and receives a general message from the first ECU 300 (540). In this case, the controller 30 identifies that the MAC address of the first ECU 300 is changed, and discards the general message.

Meanwhile, when the controller 30 receives the Ethernet packet from the second ECU 400 (550), since both the MAC address and IP address of the second ECU 400 are normal, the controller 30 cannot determine a hacked state of the second ECU 400.

Accordingly, the controller 30 performs the DPI on the Ethernet packet received from the second ECU 400 to identify the request service ID recorded in the payload. In this case, data (e.g., 01 FE 80 01 00 00 00 07 0E 00 E0 00 2E F8 10) are recorded in the payload of the Ethernet packet, and 2E is recorded in the data byte #12.

Thereafter, as the request service ID recorded in the data byte #12 of the payload in the Ethernet packet is the same as any one of 31, 34, 36, 37, 2F, 2E, or 3D, the controller 30 determines that the Ethernet packet to be an inappropriate Ethernet packet received from the hacked second ECU 400 and discards the Ethernet packet.

As a result, the controller 30 can filter inappropriate Ethernet packets based on the ACL, and can also filter inappropriate Ethernet packets based on the DPI in the data link layer.

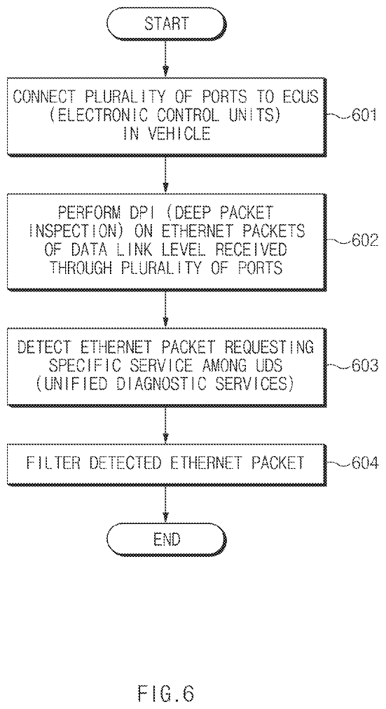

FIG. 6 is a flowchart of an Ethernet packet filtering method according to an embodiment of the present disclosure.

First, the plurality of ports 20 are connected to the ECUs in the vehicle (601).

Thereafter, the controller 30 performs the DPI on the Ethernet packets of the data link level received through the plurality of ports 20 (602).

Thereafter, the controller 30 detects an Ethernet packet requesting a specific service among Unified Diagnostic Services (UDS) (603).

Thereafter, the controller 30 filters the detected Ethernet packet (604).

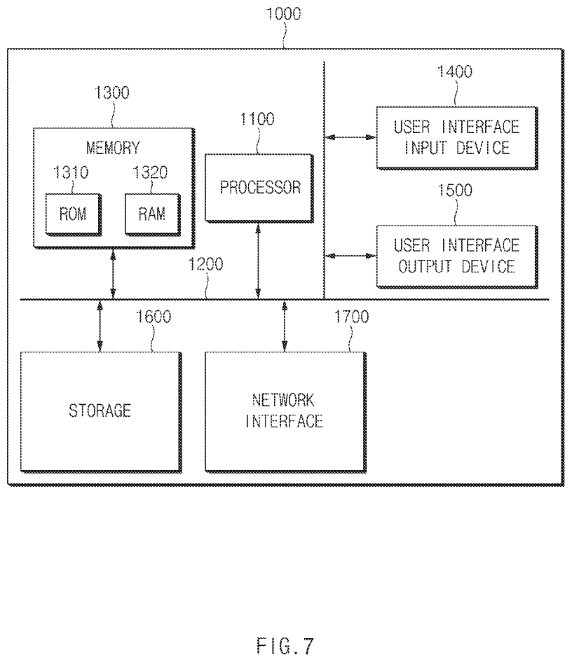

FIG. 7 is a block diagram illustrating a computing system for executing an Ethernet packet filtering method, according to an embodiment of the present disclosure.

Referring to FIG. 7, the Ethernet packet filtering method according to an embodiment of the present disclosure described above can also be implemented through a computing system. A computing system 1000 can include at least one processor 1100, memory 1300, a user interface input device 1400, a user interface output device 1500, storage 1600, and a network interface 1700, which are connected with each other through a system bus 1200.

The processor 1100 can be a central processing unit (CPU) or a semiconductor device that processes instructions stored in the memory 1300 and/or the storage 1600. Each of the memory 1300 and the storage 1600 can include various types of volatile or nonvolatile storage media. For example, the memory 1300 can include a read only memory (ROM) 1310 and a random access memory (RAM) 1320.

Accordingly, the operations of the method or algorithm described in connection with the embodiments disclosed in the specification can be directly implemented with a hardware module, a software module, or a combination of the hardware module and the software module, which is executed by the processor 1100. The software module can reside on a storage medium (i.e., the memory 1300 and/or the storage 1600) such as a random access memory (RAM), a flash memory, a read only memory (ROM), an erasable and programmable ROM (EPROM), an electrically EPROM (EEPROM), a register, a hard disk drive, a removable disc, a compact disc-ROM (CD-ROM), or any combination thereof. The storage medium as an example can be coupled to the processor 1100. The processor 1100 can read out information from the storage medium and can write information into the storage medium. Alternatively, the storage medium can be integrated with the processor 1100 in a single chip/device. The processor 1100 and storage medium can be implemented with an application specific integrated circuit (ASIC), for example. The ASIC can be provided in a user terminal. Alternatively, the processor 1100 and storage medium can be implemented with separate components in the user terminal.

According to an embodiment of the present disclosure, Ethernet packets received from hacked ECUs (Electronic Control Units) can be filtered as well as the hacked ECUs can be detected among the ECUs in the vehicle, by performing a DPI (Deep Packet Inspection) on Ethernet packets of the data link level (Layer 2) received from the ECUs in the vehicle, detecting an Ethernet packet requesting a specific service among Unified Diagnostic Services (UDS), and filtering the detected Ethernet packet.

In addition, according to an embodiment of the present disclosure, Ethernet packets received from hacked ECUs (Electronic Control Units) can be filtered as well as the hacked ECUs can be detected among the ECUs in the vehicle, in a state having a table in which commands for blocking a specific service request Ethernet packet ingress through an unauthorized port are recorded, by performing a DPI (Deep Packet Inspection) on Ethernet packets of the data link level (Layer 2) received from the ECUs in the vehicle and filtering inappropriate Ethernet packets based on the table.

The above description is merely illustrative of technical ideas of the present disclosure, and those of ordinary skill in the art to which the present disclosure pertains will be able to make various modifications and variations without departing from the essential characteristics of the present disclosure. Therefore, embodiments of the present disclosure are not necessarily intended to limit the technical spirit of the present disclosure, but are provided only for illustrative purposes. The scope of protection of the present disclosure should be construed by the attached claims, and all equivalents thereof should be construed as being included within the scope of the present disclosure.

What is claimed is:

1. An Ethernet packet filtering apparatus comprising:
a plurality of ports configured to be connected to electronic control units (ECUs) in a vehicle; and
a controller configured to perform a deep packet inspection (DPI) on Ethernet packets of a data link level received through the ports, to detect an Ethernet packet requesting a specific service among unified diagnostic services (UDS), and to filter the detected Ethernet packet.

2. The apparatus of claim 1, wherein the controller is further configured to filter the Ethernet packet in response to an ID corresponding to the specific service being recorded in a payload of the Ethernet packet.

3. The apparatus of claim 2, wherein the controller is further configured to inspect data byte #12 of the payload in the Ethernet packet.

4. The apparatus of claim 1, wherein the specific service comprises any one of Routine Control, Request Download, Transfer Data, Request Transfer Exit, Input/Output Control, Write Data By Identifier, and Write Memory By Address.

5. The apparatus of claim 1, wherein the Ethernet packet filtering apparatus is an Ethernet switch operating at a data link layer.

6. An Ethernet packet filtering apparatus comprising:
a storage configured to record a table of commands for blocking specific service request Ethernet packets ingress through unauthorized ports; and
a controller coupled to the storage, the controller being configured to perform a deep packet inspection (DPI) on Ethernet packets of a data link level received from electronic control units (ECUs) in a vehicle and to filter out an inappropriate Ethernet packet based on the table.

7. The apparatus of claim 6, wherein the controller is further configured to determine the Ethernet packet as the inappropriate Ethernet packet in response to an ID corresponding to the specific service being recorded in a payload of the received Ethernet packet.

8. The apparatus of claim 7, wherein the controller is further configured to inspect data byte #12 of the payload in the Ethernet packet.

9. The apparatus of claim 6, wherein the specific service is any one of Routine Control, Request Download, Transfer Data, Request Transfer Exit, Input/Output Control, Write Data By Identifier, and Write Memory By Address.

10. The apparatus of claim 6, wherein the Ethernet packet filtering apparatus is an Ethernet switch operating at a data link layer.

11. A method of Ethernet packet filtering, comprising:
performing, by a controller, deep packet inspection (DPI) on Ethernet packets of a data link level received through ports, the ports being connected to electronic control units (ECUs) in a vehicle;
detecting, by the controller, an Ethernet packet requesting a specific service among unified diagnostic services (UDS); and
filtering the detected Ethernet packet.

12. The method of claim 11, wherein the filtering of the detected Ethernet packet comprises filtering, by the controller, the Ethernet packet in response to an ID corresponding to the specific service being recorded in a payload of the Ethernet packet.

13. The method of claim 12, wherein the filtering of the detected Ethernet packet further comprises inspecting, by the controller, data byte #12 of the payload in the Ethernet packet.

14. The method of claim 11, wherein the specific service is any one of Routine Control, Request Download, Transfer Data, Request Transfer Exit, Input/Output Control, Write Data By Identifier, and Write Memory By Address.

15. The method of claim 11, wherein the performing of the DPI comprises performing, by the controller provided in an Ethernet switch operating in a data link layer, the DPI on the received Ethernet packet.

16. The method of claim 11, wherein the filtering the detected Ethernet packet comprises filtering, by the controller, out an inappropriate Ethernet packet based on a stored table.
